(19) United States
(12) Patent Application Publication
(10) Pub. No.: US 2022/0356726 A1
(43) Pub. Date: Nov. 10, 2022

(54) CAMPING AWNING

(71) Applicant: FANUC CORPORATION, Ferntreegully (AU)

(72) Inventor: Jack Venter, Ferntreegully (AU)

(21) Appl. No.: 17/739,062

(22) Filed: May 6, 2022

(30) Foreign Application Priority Data
May 7, 2021 (AU) 2021901371

(51) Int. Cl. E04H 15/08; H02S 20/30; H02S 30/20

(52) U.S. Cl. CPC E04H 15/08; H02S 20/30; H02S 30/20

(57) ABSTRACT

A camping awning mountable to a vehicle at or above head-height comprises a core having a cylinder extending between a pair of spaced ends of the core, an awning sheet adapted to be returned onto the core in a storage state, the awning sheet also adapted to be paid out to present an upper surface of the awning sheet, in an extended state, and a flexible solar charging device attached to or forming part of the upper surface. The solar charging device is adapted to bend with the awning sheet as it is returned onto the core, such that the awning sheet including the solar charging device is adapted to be fully returned onto the core, and covers by area at least 20% of the upper surface when the awning sheet is fully paid out.

### FIELD OF INVENTION

This invention relates to a camping awning.

### BACKGROUND

The following references to and descriptions of prior proposals or products are not intended to be, and are not to be construed as, statements or admissions of common general knowledge in the art. In particular, the following prior art discussion should not be assumed to relate to what is commonly or well known by the person skilled in the art, but to assist in the inventive process undertaken by the inventor(s) and in the understanding of the invention.

Camping awnings have been described in which the awning is attached via brackets or some other preferably releasable connection to the side of a vehicle, such as a van, caravan or other camping vehicle. Prior art camping awnings may include an awning sheet wound onto a core with spring bias and adapted to be paid out or extended to form a sun screen or weather protection camping accessory.

There is a need for improved camping awnings or useful alternatives thereto.

### SUMMARY

In one aspect of the invention, there is provided a camping awning mountable to a vehicle at or above head-height, the camping awning comprising:
a core having a cylinder extending between a pair of spaced ends of the core;
an awning sheet adapted to be returned onto or about the core in a storage position, the awning sheet also adapted to be paid out to present an upper surface of the awning sheet, in a spread, paid out position;
a flexible solar charging device attached to or forming part of the upper surface, wherein the solar charging device:
is adapted to bend with the awning sheet as it is returned onto the core, such that the awning sheet including the solar charging device is adapted to be fully returned onto the core; and
covers by area at least 20% of the upper surface when the awning sheet is fully paid out.

In another aspect of the invention, there is provided a camping awning mountable to a vehicle, the camping awning having a storage state and an extended state and comprising:
a core;
an awning sheet attached to the core and adapted to be retained about the core when the apparatus is in the storage state and extended from the core when the apparatus is in the extended; and
a flexible solar charging device attached to or forming part of an upper surface of the awning sheet, wherein the solar charging device is able to conform to the shape of the awning sheet when the camping awning is in the storage state and the extended state.

In another aspect of the invention, there is provided a camping awning mountable to a vehicle, the camping awning having a storage state and an extended state and comprising:
a core;
an awning sheet attached to the core and adapted to be retained about the core when the apparatus is in the storage state and extended from the core when the apparatus is in the extended state; and
an entertainment rack located, in the extended state, under the awning sheet.

The core may be a bar about which the awning sheet is rolled or folded for storage, and unrolled or unfolded in an extended, operational position.

The camping awning may further include an entertainment rack located under the awning sheet.

The entertainment rack includes a pair of speakers and an electronic control console that may be powered by the solar charging device.

The awning sheet preferably includes a backing sheet to which the flexible solar charging device is attached by a releasable attachment device.

The flexible solar charging device preferably includes a strip of material comprising ethylene tetrafluoroethylene (ETFE) or a copper indium gallium selenide solar cell (CIGS cell).

The vehicle may be a caravan, camper trailer, van, utility vehicle, fifth wheeler, or other vehicle to which a rollable awning may be mounted.

The core may be in the form of a cylinder extending between a pair of spaced ends of the core. The core may be mounted for rotation about a fixed axis relative to the vehicle. The camping awning may include brackets or other mounting means to mount the core to the vehicle. The core may be spring biased to return the awning sheet, whereby a spring preferably housed in the core may be used as the rotating motive force to return the awning sheet by reeling it in.

Alternatively, the core is attached to an outer edge of the awning sheet. The awning sheet may be returned onto or about the core by using the core as a centre rod or beam to which the outer edge of the awning sheet is attached, and manually rotating the core whereby to roll the awning sheet around the core until the awning sheet rolled around the core is returned to a storage position adjacent the vehicle.

The camping awning may optionally include a cover in the form of a flexible cover, housing or hood that covers the camping awning in the storage position/state in which the awning sheet is retained about the core, for example by rolling or folding up the awning sheet so that it is neatly rolled onto the core, or nestled up against or near-adjacent the core. The cover may provide weather protection therefor during storage or travel.

Whilst the camping awning is preferably mountable above head height, the specific height that qualifies as being above an individual's head height varies from individual to individual. The preferable mount height of the camping awning is also a function of the maximum height that the camping awning may be mounted on the vehicle. That is, the vehicle may have one or more mounting points. The available mounting points on the vehicle may be lower than an individual's head height and the mounting height in such case is then pragmatically as high as achievable given the height limitations of the vehicle mounting point. The mounting points may be structural, reinforced, or inherently strong and rigid members of the vehicle, such as roof rails or side pillars. To ameliorate the problem of a vehicle with a lack of height, the mounting of the awning may include brackets that extend upwardly, either as fixed or articulated arms, from the one or more mounting points. Preferably, the term “head height” refers to a height above ground or floor level that is at least 1.8 m and preferably at least 2 m.

The core is preferably made of extruded or cast metal, including aluminium or stainless steel. The core may be a rod or a beam made of metal, wood or plastic or a composite of two or more of those materials. The core may be cylindrical and include an elongated slot adapted to receive an edge bead of the awning sheet to retain an edge of an internal side of the awning sheet that is, in use, permanently attached to the core. The core is preferably hollow to define an inner cavity, which may be a cylindrical cavity. In some examples, the core is a separate structure to the entertainment rack, while in other examples, the core and the entertainment rack form a common structure.

The inner cavity may be used to house a biasing means. The biasing means may include, for example, a spring bias. The spring bias may be an axial or torsion spring biased toward winding the awning sheet onto the core.

The diameter of the core may have a minimum dimension of about 30 mm to about 60 mm. A minimum diameter of the core can be advantageous to minimise the degree of bending of the solar charging device during winding and stowage of the awning sheet and solar charging device. A more flexible and thinner form of the solar charging device may be used closest to the internal edge of the awning sheet and a thicker, optionally more productive solar charging device material may be used toward an opposed external edge of the awning sheet. This may serve to maximise productivity, whilst reducing the potential for undesirable crushing of the solar charging device. However, preferably the same flexible material is used for the solar charging device across the upper surface to minimise the number of component types required to complete the camping awning and to minimise production costs.

In some embodiments, the camping awning may not comprise a core. The camping awning may instead comprise a housing (which, in some embodiments, may be the entertainment rack). In the storage state, the awning sheet is rolled onto itself and received on, against or within the housing. In the extended state, the awning sheet is extended from the housing.

The awning sheet may include a substrate material comprised of awning material as known in the art, such as polyethylene, nylon, canvas or one of a variety of woven polymeric sheet materials. The solar charging device may comprise a strong, thin and flexible material that can itself perform as the awning sheet without backing.

The awning sheet may include attachment devices on its upper surface. The attachment devices may be adapted to receive and secure a plurality of modular solar charging devices. The upper surface may include a plurality of pockets or sleeves, each adapted to receive a flexible solar panel or solar material. Alternatively, or in addition, the attachment device on the upper surface may be in the form of adhesive tape, press snap fasteners or studs, hook and loop material strips, magnetic tabs or strips, or zip strips. Such releasable attachment devices allow removal of the solar charging devices from the awning sheet when not needed, or for maintenance or replacement.

The solar charging device may be in the form of one or more strips of material. The strips may be between 50-1000 mm wide, preferably about 500-1000 mm wide. The strips may be between about 500-2500 mm long, preferably about 1500-2000 mm long, and between about 1-3 mm thick. The source material may be mounted on a reel and be of indefinite length. The length may be determined by the size of the attachment device or the length of the awning sheet, which may be between 2-6 m, and preferably about 2.4 m for the typical 4 wheel drive (4WD) camping awning.

Particularly preferred materials which may be used to form the solar charging device include a strip of material comprising ethylene tetrafluoroethylene (ETFE). ETFE is a fluorine-based plastic that has high corrosion resistance and strength over a wide temperature range. ETFE is also known under the brand name Tefzel™.

Another preferred material for formation of the solar charging device is a copper indium gallium selenide solar cell (CIGS cell). The CIGS cell provides a thin-film solar cell material. Advantageously, the solar charging device may be laminated for weather protection. Alternatively, the pocket or sleeve may provide a transparent upper surface whereby sun light may easily transmit through the pocket or sleeve outer surface whereby to strike the solar charging device.

The camping awning may include an electrical system that is solar charged. The electrical system may be charged by the solar device forming part of an awning sheet.

The camping awning may include at least one electrically powered accessory, such as an audio system including one or more speakers. The electrically powered accessory may include one or more lights, such as an LED light, LED lights or one or more LED strips, and or a cinematic projector. The electrically powered accessory may include an amplifier adapted to control speakers and be mounted on the entertainment rack. The electrically powered devices may be mountable to an entertainment rack, which may include a cylinder, RHS, housing, gantry or beam. The entertainment rack may be adapted to support an internal edge of the awning sheet. The entertainment rack may be adapted to be nestled under the core. The entertainment rack may be controllable by a solar-powered controller, optionally with a remote controlling device.

The light may be in the form of single LED lights, or an LED strip. The strip may be attached to a length of the core, such that it is exposed when the awning sheet is fully paid out. The audio system may include a pair of speakers, one at each end of the entertainment rack, and optionally one or more central speakers either side of a console located centrally on the entertainment rack.

The entertainment rack may include a housing. The housing may have an internal cavity. The internal cavity may house a battery to which the solar charging device is connected and used to recharge the battery. The battery may be remotely stored in or on the vehicle or in or on a secondary towing vehicle, for example where the vehicle is a caravan or fifth wheeler.

### BRIEF DESCRIPTION OF THE DRAWINGS

The invention may be better understood from the following non-limiting description of preferred embodiments, in which:

FIG. 1 is an upper perspective view of a camping awning according to a first embodiment shown in an extended state;

FIG. 2 is an upper perspective view of a camping awning housing according to a second embodiment shown in an extended state;

FIG. 3 a front schematic view a camping awning according to a third embodiment;

FIG. 4 a front schematic view a camping awning according to a fourth embodiment;

FIG. 5 is an upper perspective view of the camping awning according to the third embodiment showing a cinematic option;

FIG. 6 is a side perspective view of a portion of a camping awning in an extended state according to a fifth embodiment;

FIGS. 7a and 7b are perspective underside views of a portion of the camping awning according to the fifth embodiment;

FIG. 8 is an upper perspective view of a camping awning according to a sixth embodiment shown in paid out position;

FIG. 9 is a schematic front view of the camping awning according to a seventh embodiment mounted on a vehicle in the form of a caravan and shown in a storage position; and

FIG. 10 is a schematic front view of the camping awning according to the seventh embodiment mounted on a 4WD vehicle and shown in a storage position.

FIGS. 11 to 13 show a front, front right perspective and rear right perspective view respectively of an entertainment rack.

FIG. 14 shows a perspective view of an end cap for the entertainment rack shown in FIGS. 11 to 13.

FIGS. 15 to 17 illustrate a camping awning comprising the entertainment rack of FIGS. 11 to 13.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention. In describing the various embodiments of the invention, like features will be referred to using like references, with references for features of each embodiment generally preceded by 1, 2, 3, or followed by a Roman numeric sequence, such as i, ii, iii, etc. or an alphabetical sequence such as a, b, c, relative to the corresponding feature of the first embodiment. For example, a feature 10 of the first embodiment may represented as 110, 210, 310, (or n10), or 10a, 10b, 10c, (or 10x) or 10i, 10ii, 10iii, (or 10r) etc. in second, third and fourth embodiments, respectively.

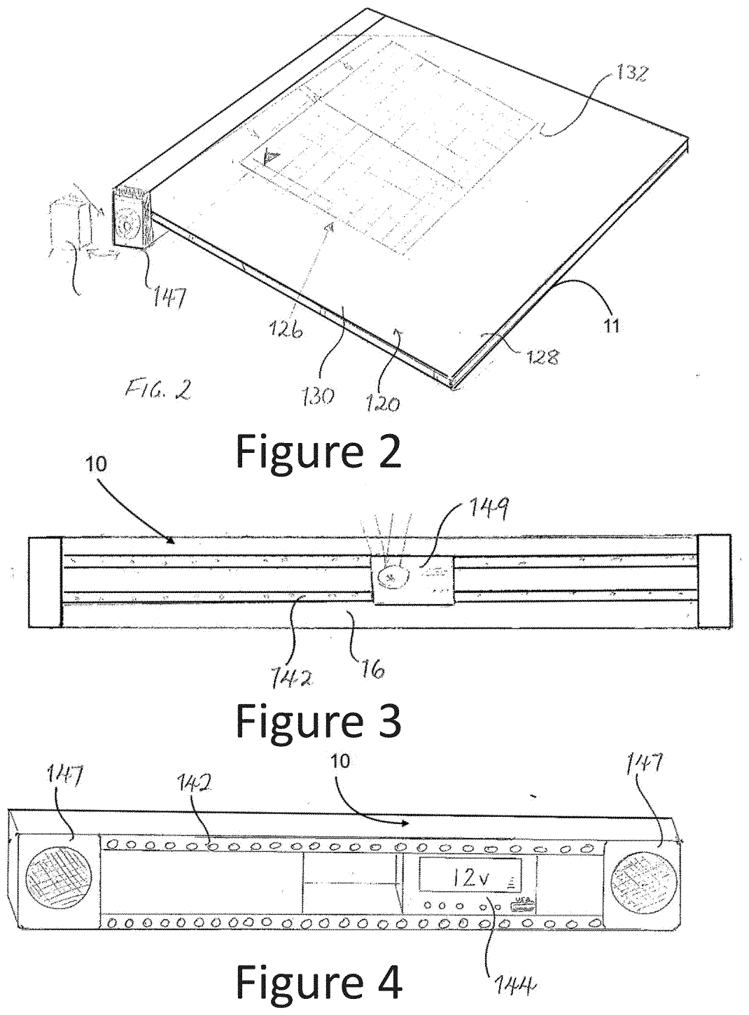

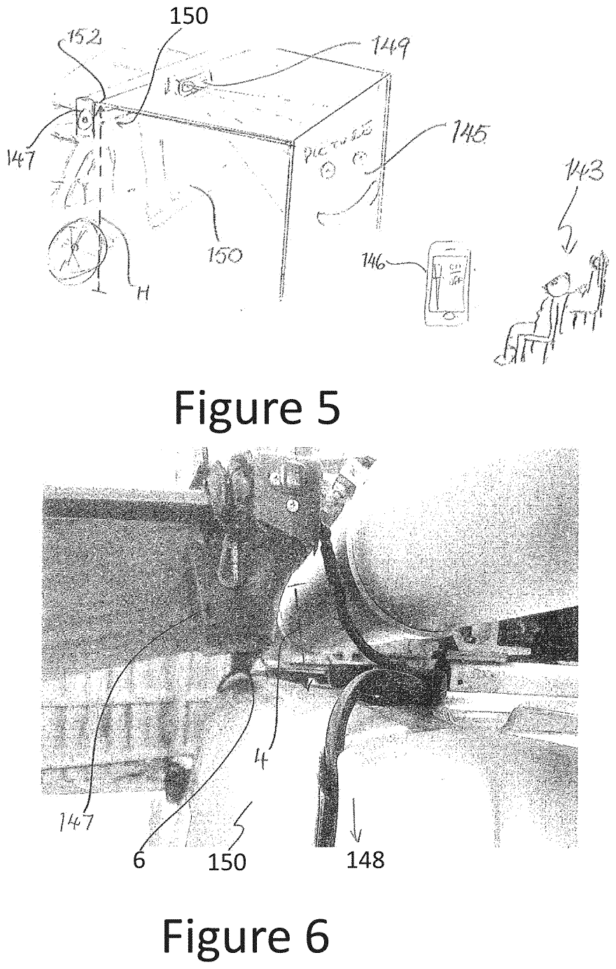

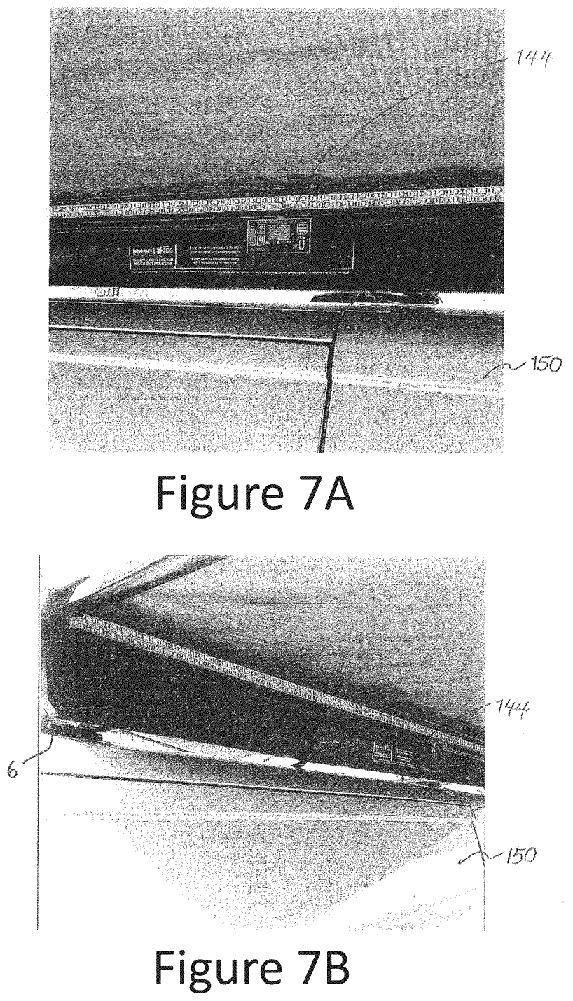

In FIGS. 2-10 of the drawings, there is shown a camping awning 1. The camping awning 1 is mountable to a vehicle 150 at or above head-height 152. The camping awning 1 comprises an awning sheet 120, a core 11 and an entertainment rack 10. The camping awning 1 has a storage state for transportation and an extended or paid out state for use. FIG. 2 shows the awning sheet 120 in an extended state, extending between the core 11 and entertainment rack 11. The extended state includes states in which the awning sheet 120 is not extended to its maximum length 124.

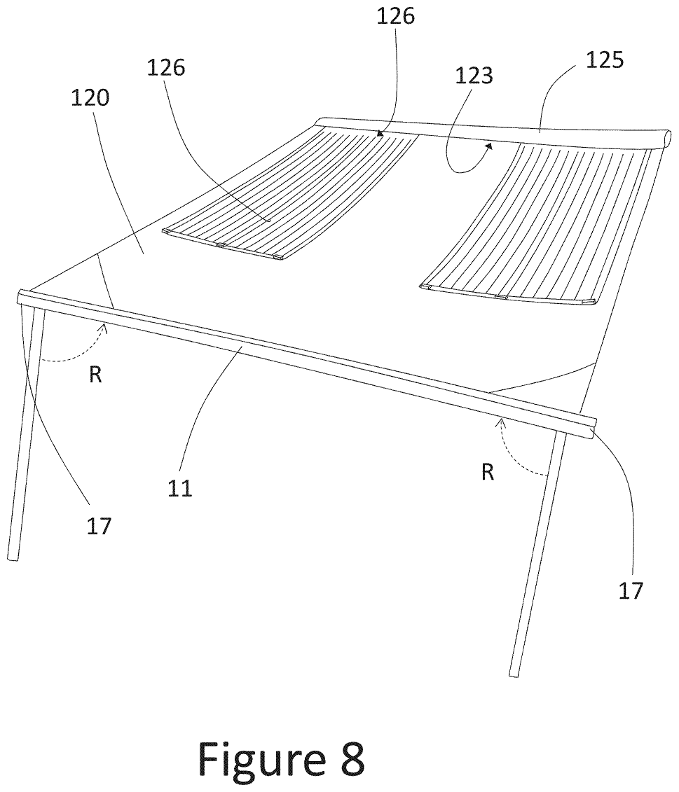

The entertainment rack 10 has a cylinder extending between a pair of spaced ends 8. An awning sheet 120 is adapted to be returned, for example by being rolled, onto the core 11 in a storage position. In the extended state, the core 11 is positioned at an outer edge 128 of the awning sheet 120 and the core 11 comprises a simple rod or beam 11. In the extended, paid out, unfolded or unrolled state shown in FIG. 8, the core 11 is supported at either end 17 by fold out poles 19 that are hingedly attached to the bar ends 17. The poles 19 are adapted to fold up in the rotational direction R into a position substantially parallel with the core 11, when the camping awning is in the storage state, enabling the awning sheet to be rolled or folded around the core 11 and stowed against the entertainment rack 10.

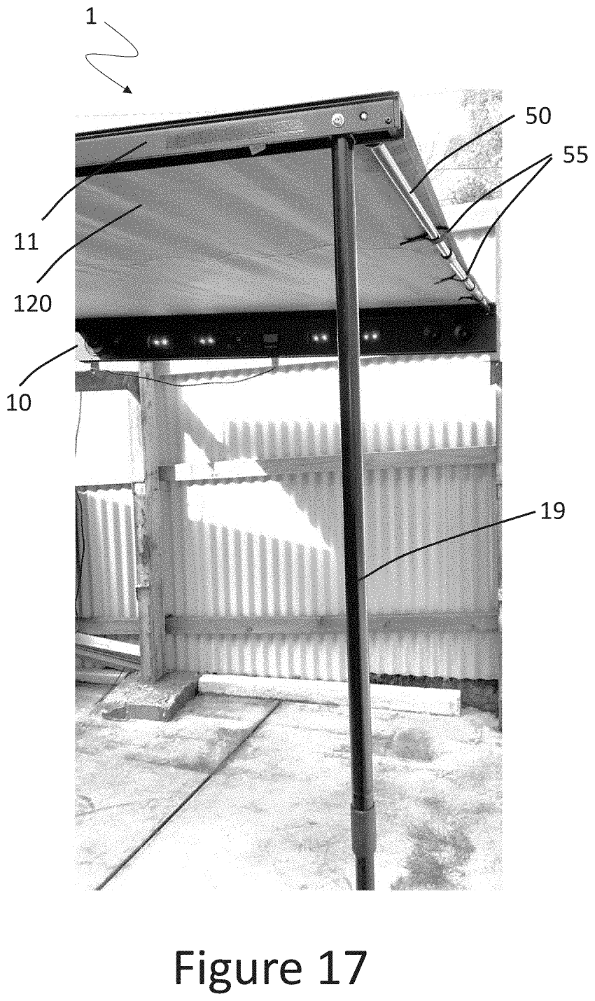

In another embodiment shown in FIGS. 16 and 17, the core 11 may comprise an elongate channel. The fold out poles 19 may be received in the channel of the core 11 when folded up in the direction R. The poles 19 may be telescopically extendable for an adjustable support height.

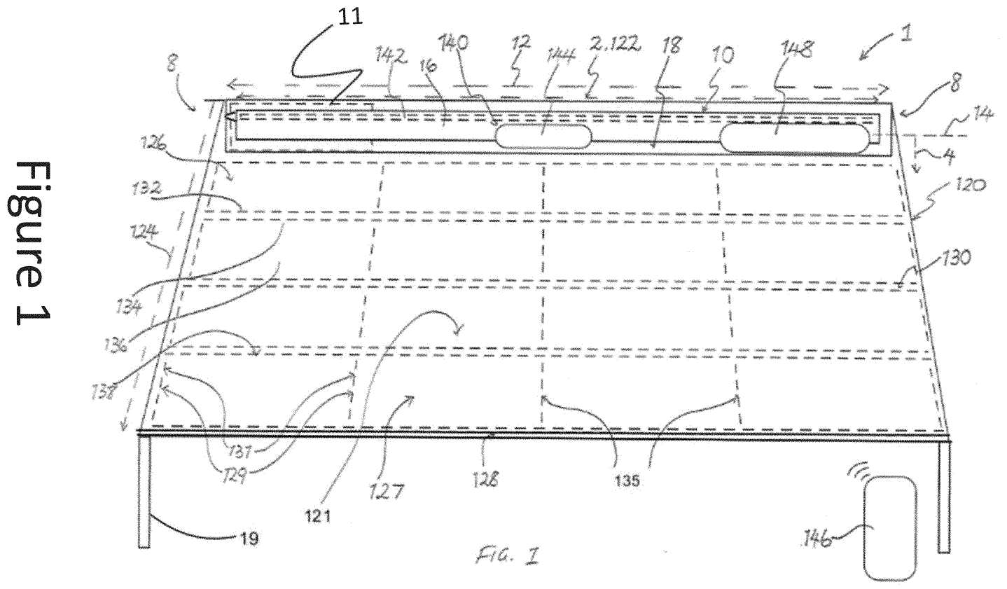

In another arrangement shown schematically in FIG. 1, the entertainment rack 10 and the core 11 are merged and the awning sheet 120 is adapted to be extended against a spring bias to present an upper surface 121 of the awning sheet 120, in a spread, extended state. A flexible solar charging device 126 is attached to or forms part of the upper surface 121. The solar charging device 126 is adapted to bend with the awning sheet 120 as it is rolled or folded onto the core 10, such that the awning sheet 120, including the solar charging device 126, is adapted to be fully rolled or folded onto the core 10. The solar charging device 126 covers by area at least 20% of the upper surface 121 when the awning sheet 120 is fully extended.

Camping accessories often require power, but in remote locations grid power may not be available. In a preferred embodiment, the camping awning 1 comprises a flexible and rollable solar panel sheet 120 forming awning material. The awning sheet 120 is adapted to be rolled or folded on to an awning core 10 and, like a known awning, adapted for extension optionally against spring bias. In the embodiment shown in FIG. 1, an internal spring arrangement (not shown) is adapted to reel in the sheet 120 for storage, travel and/or transport. In alternative embodiments, the awning sheet 120 is manually rolled into or onto the core 10 in the storage state.

The awning 1 is removably mountable to a vehicle 150 so that it extends substantially horizontally and is suitable for being mounted at a height H that is at or above head-height level 152 (for example, at or above 1.6 m, and preferably at or above 1.8 m). The awning 1 extends all or part of the length of a roof-line length 154 of the vehicle 150, depending on the application and the vehicle. The awning's length 2 may be between 2 m-4 m, preferably between 2.4-3 m, and most preferably about 2.4-2.5 m. A corresponding width 122 of the sheet 120 is preferably less than or equal to a core length 12. The sheet width 122 may be multiples of about 1.2 m, i.e. 2.4 m or 3.6 m, since flexible solar sheeting may conveniently be manufactured in rolls of indefinite length that have a width of 1.2 m. However, other variations in the sheet width 122 are possible.

The maximum extension length 124 of the sheet 120 is also dependent on the application. If the sheet 120 comprises flexible solar devices 126, the sheet 120 will have a sheet thickness (for example, 1-8 mm) that will generally be thicker and bulkier than the thickness of a comparable standard awning sheet material having a thickness of 1-6 mm. This can place a limitation or minimum requirement on the radial spacing 4 required between the outer surface 128 of the fully returned sheet 120 and the adjacent exterior of the vehicle 150. The radial spacing 4 is provided by end brackets 6 that axially and rotatably support respective ends 8 of the core 11 or the entertainment rack/housing 10.

In the preferred embodiment, the sheet 120 comprises a polyester, water-resistant or waterproof material. Preferably, the sheet 120 material is between 120-200 gsm, more preferably 160-180 gsm, and most preferably about 170 gsm in density. The sheet 120 material may be described as ripstop polyester and may have an Ultraviolet Protection Factor (UPF) rating of 15+, preferably 25+, and most preferably 50+.

The sheet 120 material of the preferred embodiment has a backing layer 130. The backing layer 130 is preferably woven and adapted to have features attached by stitching, ie. is sewable. In a preferred embodiment, the solar devices 126 are attached to the backing layer 130 by attachment devices 132. The attachment devices may be in the form of at least one pocket 134, with a partially or fully transparent outer surface 136, and an optionally sealable opening 138 at a side or upper end of the pocket 134.

Alternatively, each of the attachment devices 132 is in the form of a pair of opposed slots 131 adapted to receive one of the solar devices 126. Although the solar devices 126 must be flexible in a direction lateral to a longitudinal axis 14 of the core 10, the solar devices 126 may be sufficiently rigid whereby opposed edges 129 of the solar devices 126 are adapted to be braced between the opposed slots 131. In a further variation, the slots 131 may define an expanded recess (not shown) in profile in which a side bead of the solar device 126 may be trapped to secure the solar device 126 on the backing layer 130.

Alternatively, the attachment device 132 may be provided in the form of strip fasteners 135, such as adhesive tape, press snap fasteners or studs, hook and loop material strips, magnetic strips or zip strips.

The solar devices 126 of the preferred embodiment are advantageously in the form of solar panels 127. Each of the solar panels 127 may be received in one of the pockets 134. The panels may be laminated for hail and water resistance.

In a particularly preferred form, the solar devices 126 include strips of copper indium gallium selenide solar cell (or CIGS cell, sometimes CI(G)S or CIS cell) is a thin-film solar cell used to convert sunlight into electric power.

The solar devices 126 are replaceable and modular, whereby faulty, damaged or worn individual solar devices 126 may be replaced during maintenance or repair. The solar panels 127 may be, for example, provided in strips that are 500-1000 mm in width (in the direction lateral to the longitudinal axis 14). More preferably, the solar panels 127 may be provided in strips that are about 600 mm in width and cut to length.

Preferably the solar panels and the attachment of the solar panels to the awning sheet are configured to reduce or eliminate crushing, cracking, fatigue and wear over multiple cycles of pay-out/extension and reel-in.

The solar panel and awning can be housed in a single protective covering that will protect both when the camping awning is in the storage state.

The solar devices 126 may form part of a solar powered arrangement 140 that is configured to power electrically powered devices associated with the awning 1. For example, the solar powered arrangement 140 may include a light 142 extending along a base 16 on or adjacent the entertainment rack 10. The base 16 may be a region immediately below the internal edge 123 of the awning sheet 120 when the sheet 120 is in an extended state. The light 142 may be in the form of an LED strip. The internal edge 123 is attached by or to a slot, strip or bar 125 forming part of or fixed to the entertainment rack 10.

The solar powered arrangement 140 may include a pair of speakers 147 mounted at either end 8 of the entertainment rack 10 to provide audio for, for example, a cinema, radio or music system.

The solar powered arrangement 140 may include a solar controller 144 adapted to control the operations of the solar powered arrangement 140 and its associated electrically powered devices.

The solar powered arrangement 140 may have a battery storage device, such as a deep cycle secondary battery 148 connected to the vehicle's 150 electrical system, or may be independent and dedicated to the solar powered arrangement 140. The dedicated battery 148 may be mounted in the entertainment rack's 10 hollow centre 18. The battery may have a capacity of 12 or 24V.

The electrically powered devices may be powered by the battery 148 and the battery may in turn be charged via the controller 144 by the solar devices 126. Electrical connections may be in the form of USB or other suitable cabling.

The controller 144 may be remotely controllable via a RF or Bluetooth connected remote control hand-held device 146.

The solar powered arrangement may include one or more of side speakers 147 at either end 8 of the core 10 and central speakers 47 either side of the controller 144. By integrating the solar powered arrangement into the camping awning, many devices can conveniently be stored and used during a camping trip. Furthermore, examples of the invention may save luggage space in vehicles used for transporting camping equipment.

To provide a camping cinema, a projector 149 may be mounted on the entertainment rack 10 in the region 16 or immediately below, for example attached to a housing or cover of the awning 1. A drop-down screen 145 may be provided on which the projector 149 casts images, optionally in reverse, depending on where viewers 143 are to be positioned relative to the screen 145. In some examples, the drop-down screen 145 is an extension of the awning sheet 120.

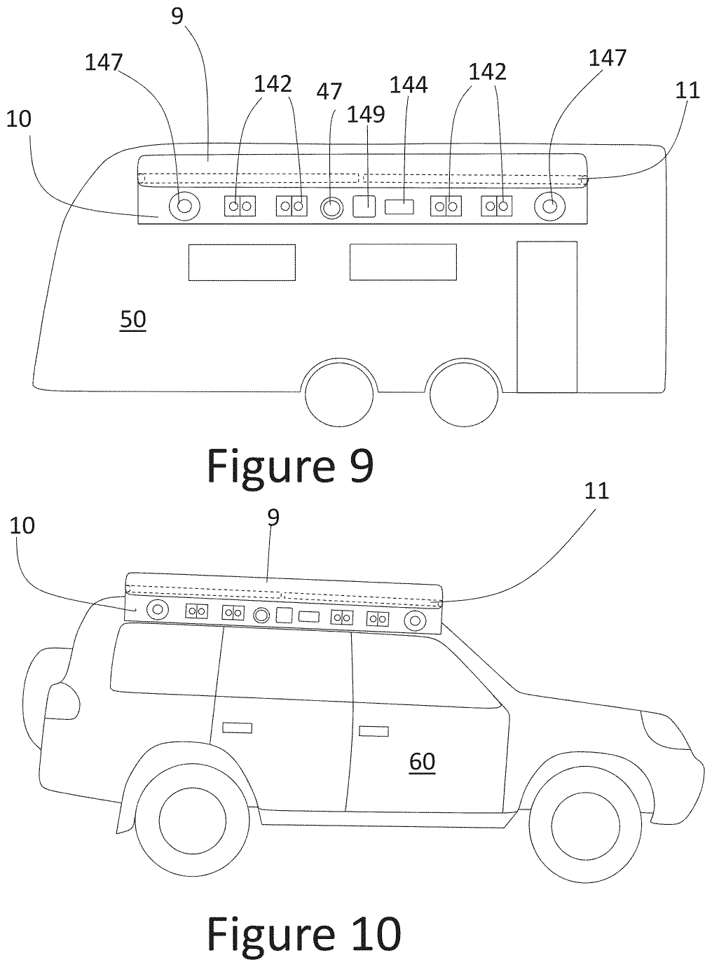

In FIGS. 9 and 10, a camping awning 1 according to a seventh embodiment is shown in a stowed or storage state on variously a caravan 50 and a four wheel drive (4WD) 60. The stowed camping awning 1 is shrouded or enclosed in a waterproof cover 9. The cover 9 may cover the stored awning sheet 120 and core 11 or may be extended to cover the entertainment rack 10 as well. In this embodiment of the invention, advantageously, a single cover can be used to protect the awning sheet 120 and devices comprised in the entertainment rack 10.

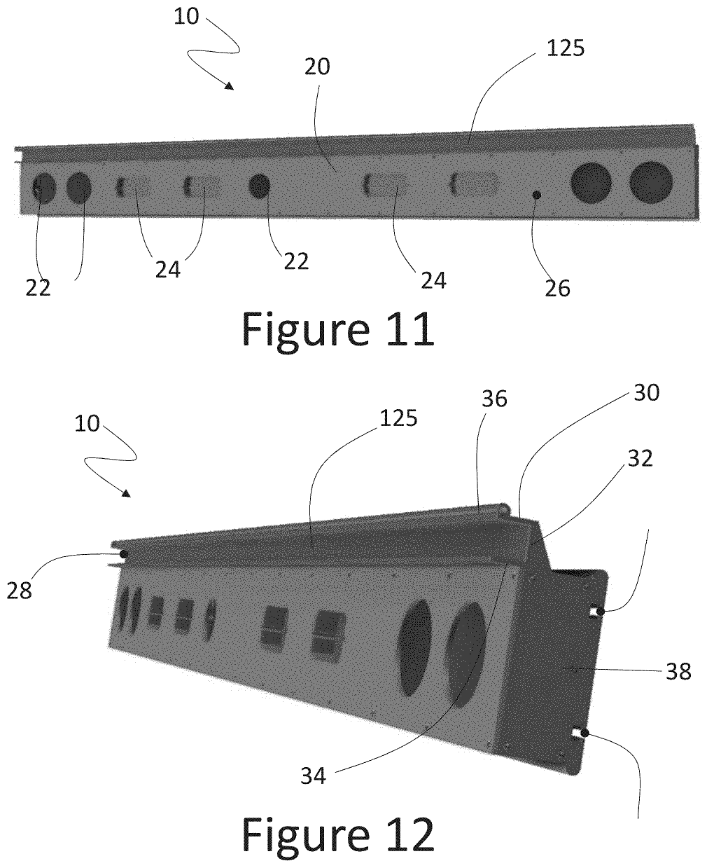

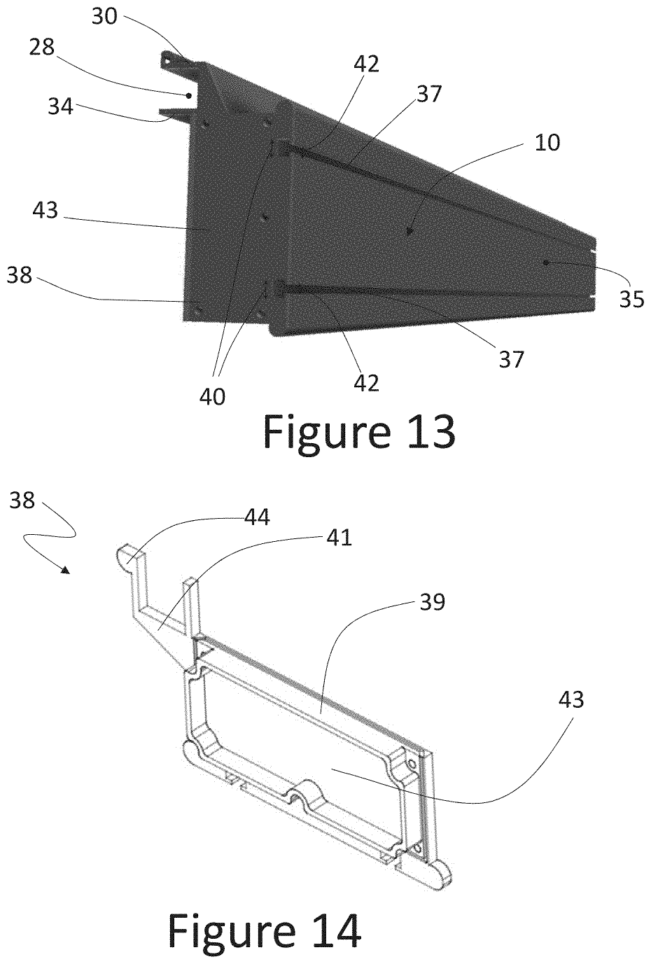

Shown in FIGS. 11 to 13 is an exemplary entertainment rack 10 without any devices fitted. The entertainment rack 10 comprises a body portion 20 in which various devices are to be fitted. The body portion is a hollow extrusion to allow for cabling from each device to pass through the entertainment rack 10. The body portion 20 of the entertainment rack 10 is of a constant cross-section along its length. More particularly, the body portion 20 is of a substantially rectangular cross-section. Furthermore, in use, the hollow interior of the entertainment rack 10 encloses the rear of the devices that are fitted to the entertainment rack 10.

The body portion 20 has apertures 22, 24 formed in at least one face, so as to permit the installation of devices to the entertainment rack 10. In the illustrated example, the body portion 20 has an array of apertures including circular apertures 22 and rectangular apertures 24 formed in a front face, which, in use, would face in the direction of extension of the awning sheet 120. In alternative examples, the entertainment rack 10 may have apertures of any shape. Furthermore, alternative entertainment racks 10 may have apertures of all the same shape.

In the illustrated example the apertures 22, 24 are shaped so that one or more of lights/LEDs (142), speakers (147), controllers (144) and projectors (149) may be fitted. In alternative examples of the entertainment rack 10, strip LEDs may be housed in or on the entertainment rack 10.

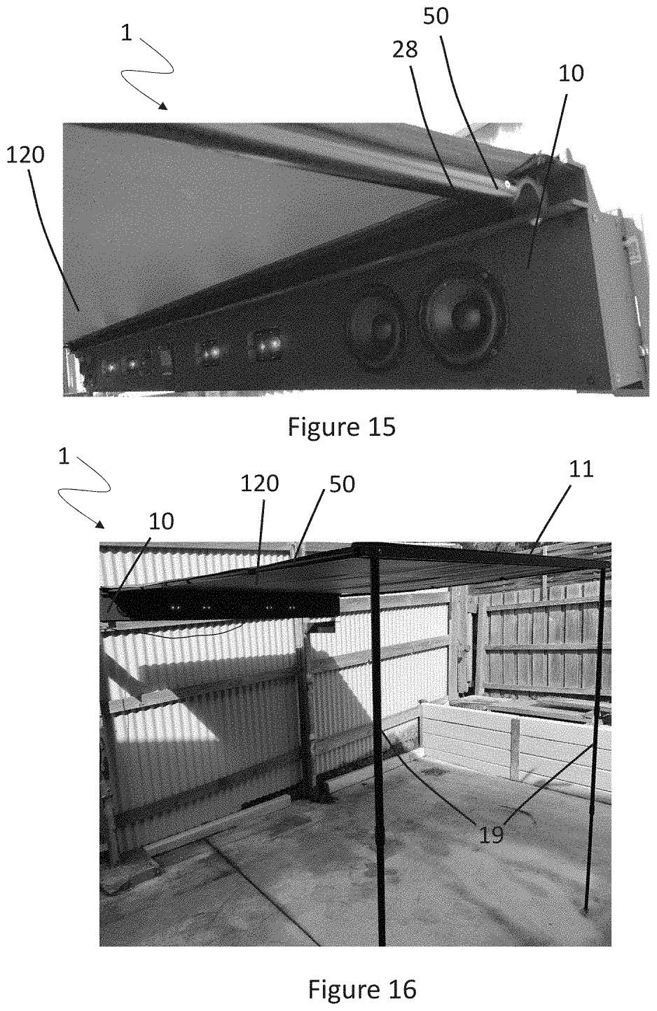

Extending from the body portion 20 is a strip 125, which is used to mount an edge 123 of the awning sheet 120 to the entertainment rack 10. The strip defines a “u-shaped” channel 28. More particularly, the u-shaped channel 28 is defined by a first 30, second 32, and third 34 wall. The first 30 and third 34 walls face each other and are adjacent the second wall 32. The second wall 32 abuts the body portion 20. The u-shaped channel 28 receives lateral support poles 50 when in the retracted/storage state. These lateral support poles 50 are shown in the extended state in FIGS. 15 to 17. Two lateral poles 50 are provided, one at each lateral side of the camping awning. Each pole 50 is pivotably attached at one end to the u-shaped channel 28, and removably attachable at the other end to the core 11 when in the extended state. The poles 50 may be telescopically extendable, so as to retract for storage in the u-shaped channel 28 and to extend to reach the core 11 when in the fully extended state. The poles 50 may be further fastened to each lateral side of the awning sheet 120 in the extended state via hook and loop fasteners 55, snap fasteners, ties, etc. The lateral support poles 50, as the name suggests, reinforce the sides of the awning sheet 120 in the extended state.

Adjacent the first wall 30 is a round channel 36 to which an edge 123 of the awning sheet 120 may be fitted. This attachment location is shown in more detail in FIG. 15.

At the rear of the entertainment rack 10 two elongate channels 37 are defined. The elongate channels 37 may be used to mount the entertainment rack to the vehicle 150. The longitudinal channels 37 are rectangular in cross-section and extend the entire length of the entertainment rack 10. One side of each longitudinal channel 37 is open along a rear face 35 of the entertainment rack 10. The height 42 of the openings to the channels 37 are less than a height 40 of the channel 37. Therefore, mounting structures can be inserted into the channels 37, whereby motion of the entertainment rack 10 transverse to the axis of the channel 37 is restricted.

The ends of the entertainment rack 10 are enclosed by end caps 38. The end caps 38 substantially conform to the shape of the entertainment rack including the strip comprising the u-shaped channel 28. The end cap 38 comprises an outer plate 43. Extending inwardly from the outer plate 42 is a skirting 39 which retains the end cap 38 in position when it is installed in the entertainment rack 10. The portion 41 of the end cap 38 covering the strip 125 does not comprise skirting, but has a portion 44 which closes the round channel 36. An awning sheet 120 can therefore be fitted into the round channel 36 and retained in place by closing both ends of the round channel 36 with the end caps 38.

Furthermore, in some examples, all the corners of the entertainment rack 10 are rounded to reduce risk of injury.

In some embodiments, the camping awning may not include the solar charging device described above. Instead, the camping awning comprises an awning sheet 120 and an entertainment rack 10, the entertainment rack configured to be located, in the extended state of the camping awning, under the awning sheet. The entertainment rack comprises arrangements for attachment to the awning sheet 120, such as channel 36 as described above. The entertainment rack may further comprise arrangements such as channel 28 for receiving support poles 50 and arrangements such as channels 37 for mounting the camping awning to the vehicle. The electronic components of the entertainment rack may be powered by an external power source, eg a separate battery or separate solar charging device.

It will be appreciated that provision of a camping awning having an entertainment rack reduces the number of items that have to be packed, unpacked, installed and uninstalled when camping. Further, in embodiments where a solar charging device is provided on the awning sheet, the entertainment devices in the entertainment rack may be conveniently powered by the solar charging device.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

While various embodiments of the present invention have been described above, it should be understood that they have been presented by way of example only, and not by way of limitation. It will be apparent to a person skilled in the relevant art that various changes in form and detail can be made therein without departing from the spirit and scope of the invention. Thus, the present invention should not be limited by any of the above described exemplary embodiments.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention. The features and components of each of the embodiments of the invention described in the detailed description and/or depicted in the accompanying drawings may be interchangeable as required, with regard to functional equivalency and compatibility. A feature or component described with reference to one but not all embodiments, if functionally and dimensionally compatible as an addition with another embodiment herein described, or substitutable with a corresponding feature or component of that other embodiment in relation to which it has not been expressly described, should be read as a potential addition or substitution to that other embodiment and as being within the scope of the invention. Furthermore, in considering a feature or component that is described in relation a particular embodiment but may be omitted from the embodiment without losing the functionality characterising the invention and without departing from the scope of the invention, unless the context and expressions used in describing the embodiment imputes that the feature or component is essential to the invention as broadly described, the omittable feature or component may be read as not being included in the embodiment.

1. A camping awning mountable to a vehicle at or above head-height, the camping awning comprising:
a core having a cylinder extending between a pair of spaced ends of the core;
an awning sheet adapted to be returned onto the core in a storage state, the awning sheet also adapted to be paid out to present an upper surface of the awning sheet, in an extended state; and
a flexible solar charging device attached to or forming part of the upper surface, wherein the solar charging device:
is adapted to bend with the awning sheet as it is returned onto the core, such that the awning sheet including the solar charging device is adapted to be fully returned onto the core; and
covers by area at least 20% of the upper surface when the awning sheet is fully paid out.

2. A camping awning mountable to a vehicle, the camping awning having a storage state and an extended state and comprising:
a core;
an awning sheet attached to the core and adapted to be retained about the core when the apparatus is in the storage state and extended from the core when the apparatus is in the extended state; and
a flexible solar charging device attached to or forming part of an upper surface of the awning sheet, wherein the solar charging device is able to conform to the shape of the awning sheet when the camping awning is in the storage state and the extended state.

3. A camping awning according claim 2, wherein the solar charging device covers at least 20% of the area of a surface of the awning sheet.

4. A camping awning according to claim 2, wherein the core is a bar attached to an edge of the awning sheet.

5. A camping awning according to claim 4, wherein the awning sheet is rolled or folded around the core when the camping awning is in the storage state.

6. A camping awning according to claim 2, wherein the awning sheet is rolled or folded within the core when the camping awning is in the storage state.

7. A camping awning according to claim 6, wherein the awning sheet is biased to return to the storage state.

8. A camping awning according claim 7, wherein the awning sheet is rolled or folded in the storage state and unrolled or unfolded in the extended state.

9. A camping awning according to claim 1, wherein the flexible solar charging device includes a strip of material comprising ethylene tetrafluoroethylene (ETFE) or a copper indium gallium selenide solar cell (CIGS cell).

10. A camping awning according to claim 1, wherein the solar charging device is releasably attached to the awning sheet.

11. A camping awning according to claim 10, wherein the solar charging device is releasably attached to the awning sheet by a backing sheet.

12. A camping awning according to claim 11, wherein the flexible solar charging device is releasably attached to the awning sheet via pockets on the upper surface.

13. A camping awning according to claim 12, wherein the camping awning further includes an entertainment rack located, in the extended state, under the awning sheet.

14. A camping awning mountable to a vehicle, the camping awning having a storage state and an extended state and comprising:
a core;
an awning sheet attached to the core and adapted to be retained about the core when the apparatus is in the storage state and extended from the core when the apparatus is in the extended state; and
an entertainment rack located, in the extended state, under the awning sheet.

15. A camping awning according to claim 14, wherein the entertainment rack includes a pair of speakers and/or lighting.

16. A camping awning according to claim 15, wherein the speakers and/or lighting is/are powered by solar charging device.

17. A camping awning according to claim 14, wherein the entertainment rack includes an electronic control console.

18. A camping awning according to claim 17, wherein the awning sheet is attached at one edge to the entertainment rack.

19. A camping awning according claim 18, wherein the entertainment rack comprises a mounting arrangement for removably attaching the camping awning to the vehicle.

20. A camping awning according to claim 19, wherein the entertainment rack comprises a channel for receiving support poles of the camping awning when in the storage state.
